(19) United States
(12) Patent Application Publication
(10) Pub. No.: US 2003/0021402 A1
(43) Pub. Date: Jan. 30, 2003

(54) System and method for providing ring in private branch exchange

(75) Inventor: Jin Hyung Kim, Gwangmyeong-si (KR)

Correspondence Address: FLESHNER & KIM, LLP, P.O. Box 221200, Chantilly, VA, 20153-1200, US

(73) Assignee: LG Electronics Inc.

(21) Appl. No.: 10/192,636

(22) Filed: Jul. 11, 2002

(30) Foreign Application Priority Data
Jul. 25, 2001 (KR) 44739/2001

(51) Int. Cl. H04M 3/42; H04M 1/00

(52) U.S. Cl. 379/207.16; 379/373.02

(57) ABSTRACT

A system and method for managing calls provides a user with a telephone ring which was previously designated in the system. The system includes a ring memory unit for storing ring data for the user, a ring-providing unit for loading the ring data designated by the user from the memory unit, and a line interface for providing the loaded ring data to a telephone of the user when the user receives a call, either from an external network or a local network such as an internal extension within a PBX system. The system is advantageous because it provides system participants with their own custom-selected rings, which prevents confusion in a multiple-user setting.

### BACKGROUND OF THE INVENTION

1. Field of the Invention

The present invention relates to a PBX (Private Branch exchange), and more particularly to a system and method for providing a specific ring designated by a user based upon a plurality of rings.

2. Background of the Related Art

Well known to those skilled in the art, a PBX is an exchange system which allows not only all personnel, for example, in an office or building, to share a predetermined number of external telephone lines but also allows those users to be connected to internal extensions which are automatically switched.

A main object of using a PBX system is to save cost which would otherwise be consumed if all users were allocated with public telephone lines. In general, unlike the public telephone lines which are owned by telephone companies, a PBX system is owned by a business entity under its responsibility. Further, although conventional PBXs have adopted analog technology, recently almost all new PBXs use digital technology.

FIG. 1 shows a conventional PBX system of the aforementioned type. As shown, the conventional PBX system has telephones 10, each of which is assigned a dedicated telephone number allocated to a particular individual, and a PBX 20 which is commonly connected to the telephones 10 and to a Public Switched Telephone Network (PSTN) or the Internet for connecting to an office line or extensions.

The PBX 20 is connected to the telephones 10 via an office line or the extensions, and has a line interface 22 for transferring ring data associated with an external call request into the telephones 10 and a control unit 23 for transferring the ring data into the line interface 22 by loading the same in receiving the external call request. Herein, the ring data may be previously stored into the control unit 23, designated as a basic ring data. The control unit 23 has a memory 24 for storing the ring data which are basically provided in the PBX 20 and data related to the operation of the PBX 20, and a switch 25 for switching a Pulse Code Modulation (PCM) data stored in the memory as the ring data into serial ports of the line interface 22.

In the conventional PBX shown in FIG. 1, upon receiving an external call request, memory 24 transmits the ring data stored therein to switch 25, and the switch 25 transmits the PCM data, which is the stored ring data switched into a bit string, into the serial ports of line interface 22. Then, line interface 22 transmits the ring data into a corresponding telephone 10 allowing this telephone to ring. Herein, the ring data can be transmitted into the corresponding telephone 10 based upon the telephone number of a subscriber corresponding to the call request.

In a process of transmitting the ring data into the telephone 10 as above, the PBX 20 simply transmits the ring data stored in the memory 24 into the telephone 10 without processing the ring data. However, transmitting the ring data stored in memory 24 into telephone 10 without processing, in order to ring the telephone, is disadvantageous because the telephone can have only one type of ring. Therefore, if the PBX system is linked to several telephones, the same ring may cause confusion among subscribers.

### SUMMARY OF THE INVENTION

An object of the invention is to solve at least the above problems and/or disadvantages and to provide at least the advantages described hereinafter.

Accordingly, one object of the present invention is to solve the foregoing problems by providing a system and method which stores a plurality of ring data types for a plurality of telephone subscribers.

Another object of the present invention to provide a system and method of the foregoing type which allows each telephone subscriber to select his or her own ring data of preference, which will be activated to ring the subscriber's telephone when receiving an incoming call.

Another object of the invention to provide a system and method of the aforementioned type which is implemented in a PBX system.

The foregoing and other objects and advantages are realized by providing a method for providing a ring to a subscriber in a PBX which includes the steps of: confirming whether a ring data designated by a subscriber exists in response to an external call request; if ring data designated by the subscriber exists, loading the ring data designated by the subscriber; and then providing the loaded ring data to the subscriber. This method may further include the steps of: loading prearranged (or default) ring data if the ring data designated by the subscriber does not exist; and providing the loaded prearranged ring data into the subscriber. Preferably, the loaded prearranged ring data is converted in series before it is provided to the subscriber.

According to another aspect of the invention, a method for providing a ring to a subscriber in a PBX includes the steps of: referring to a ring memory unit according to a unique identifier included in an external call request; if the ring data exists in the ring memory unit, loading the ring data; and then providing the loaded ring data to the subscriber.

The method for providing a ring to a subscriber in a PBX may further comprise the steps of: if the ring data does not exist in the ring memory, loading prearranged ring data; and then providing the loaded prearranged ring data to the subscriber.

According to another aspect of the invention, the ring memory unit stores at least one ring data.

According to another aspect of the invention, key buttons of a terminal are manipulated to designate the ring data stored in the ring memory unit as a ring of the subscriber.

According to another aspect of the invention, a PBX system for providing a ring to a subscriber comprises: a ring memory unit for storing at least one ring data which can be designated by the subscriber; a ring-providing unit for loading a ring data designated by the subscriber of the at least one ring data stored in said ring memory unit; and a line interface for providing the loaded ring data to the subscriber. The PBX system may further comprise: a control unit for transferring a prearranged ring data into said ring-providing unit through switching if said ring memory unit does not have the ring data designated by the subscriber.

According to the PBX system for providing a ring to a subscriber, said ring-providing unit comprises: a serial-parallel converting block for converting the prearranged ring data from said control unit in parallel; a ring-selecting block for referring to the at least one ring data stored in said ring memory unit to select a corresponding ring data as a ring of the subscriber; and a parallel-serial converting block for converting the selected ring data in series.

According to the PBX system for providing a ring to a subscriber, the ring data is referred to according to an identifier of the subscriber.

According to another aspect of the invention, a system for providing a ring to a subscriber includes: a ring memory unit for storing at least one ring data; a ring-selecting unit for referring to said ring memory unit in response to an external call request to select a ring data to be provided to the subscriber; and a parallel-serial converting unit for converting the selected ring data in series. In this system, the ring data may be selected according to a unique identifier of the subscriber included in the call request.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a structure of a conventional PBX system;

FIG. 2 is a structure of a system for providing ring in a PBX according to a preferred embodiment of the invention; and

FIG. 3 is a flow chart illustrating a method for providing a ring to a subscriber terminal when an external call request is received in a PBX according to the invention.

### DETAILED DESCRIPTION OF PREFERRED EMBODIMENTS

The following detailed description will present a system and method for providing a ring in a PBX according to a preferred embodiment of the invention in reference to the accompanying drawings.

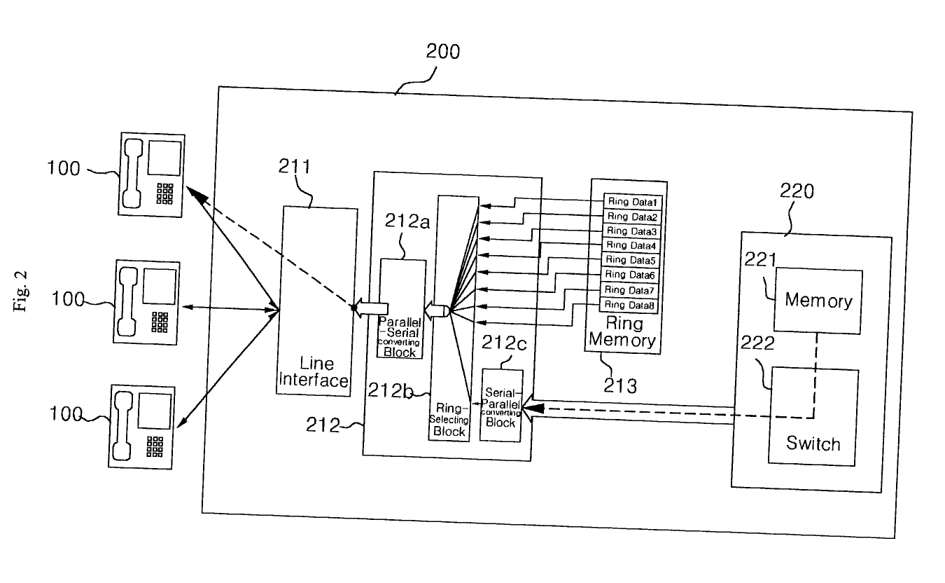

FIG. 2 is a structure of a system for providing a ring in a PBX according to a preferred embodiment of the invention. The system includes a plurality of telephones 100 allocated to individuals or companies to be used as office line or extension telephones, and a PBX 200 connected to the telephones 100 for connecting the same to an office line or extension lines. Therefore, upon receiving an external call request, the PBX 200 transfers the call request into a corresponding telephone 100 using the telephone number of a corresponding subscriber. On the other hand, upon receiving an outward call request from any of the telephones 100, the PBX 200 transfers the call request into the outside using the telephone number of a corresponding subscriber also.

The PBX 200 also includes a ring memory 213, a ring-providing unit 212, a line interface 211 and a control unit 220. The line interface 211 and the control unit 220 are the same as in a related art and thus description thereof will be omitted hereinafter.

The ring memory 213 stores at least one ring data which can be designated by a subscriber. The ring memory 213 is preferably constituted of an Erasable Programmable ROM (EEPROM). The at least one ring data is preferably stored to be connected to the telephone number of the subscriber. Of course, the at least one ring data may be stored by a system operator of the system for providing the ring at the request of the subscriber. Herein, the at least one ring data is preferably stored in parallel into the ring memory 213.

For example, when the subscriber wants to designate the ring data as his/her data, the subscriber manipulates key buttons of his/her telephone 100 to designate at least one of the ring data as his/her ring. When selecting the ring, the subscriber inputs his/her telephone number so that the telephone number of the subscriber is linked to the selected ring in the ring memory 213. The ring can be designated by using number buttons or special buttons (e.g. # or *) of the telephone 100.

When a system operator designates the ring of the subscriber, the system operator primarily operates an Operation Management Program (OMS) of the PBX, refers to the ring memory 213, and then designates the ring requested by the subscriber by inputting the telephone number of the subscriber.

The ring-providing unit 212 includes a serial-parallel converting block 212c, a ring-selecting block 212b, and a parallel-serial converting block 212a. The parallel-serial converting block 212c converts a basic (or default) ring data supported from the control unit 220 into a serial data when the subscriber designates no ring. The basic ring data is loaded from a memory 221 of the control unit 220, and inputted into the serial-parallel converting block 212c via a switch 222. The basic ring data received through the switch 222 is inputted into a bit string, which is converted into a parallel data in 8 bit unit by the serial-parallel converting block 212c. Therefore, the ring-selecting block 212b discriminates the basic ring data in 8 bit unit (i.e. 1 byte) which is converted in parallel in the serial-parallel converting block 212c, and adjusts volume based upon the discriminated ring data.

The ring-selecting block 212b selects the ring of the subscriber by loading one of the at least one ring data stored in the memory 213 in parallel in response to the external call request. In this case, the ring-selecting block 212b refers to the ring memory 213 based upon the subscriber's telephone number included in the call request to confirm whether the ring memory 213 stores a ring data corresponding to the subscriber's telephone number, and loads the ring data corresponding the subscriber's telephone number, if any.

When the ring is not designated by the subscriber, the ring-selecting block 212b selects the basic ring data which is received from the control unit 220 and converted in parallel as the ring of the subscriber corresponding to the telephone number included in the call request.

Therefore, upon selecting the ring data received from the ring memory 213 or the memory 221 of the control unit 220, the ring-selecting block 212b can adjust the ring data into a predetermined level of volume.

The parallel-serial converting block 212a is necessary for converting the ring data in series which is selected in the ring-selecting block 212b and volume-adjusted in necessity. The ring data is converted into a bit string so as to be transferred into the telephone 100 via the line interface 211.

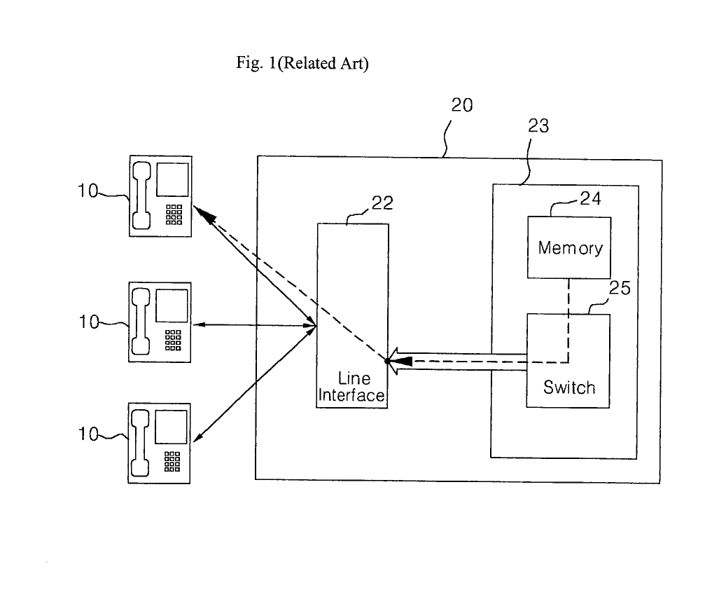

Referring to FIG. 2 again, the line interface 211 converts the ring data received from the parallel-serial converting block 212a into an analog data, and transfers the converted analog ring data into the telephone 100. This process is the same as described in FIG. 1, and thus description thereof will be omitted.

Hereinafter, a method for providing a ring in a PBX according to an embodiment of the present invention is described.

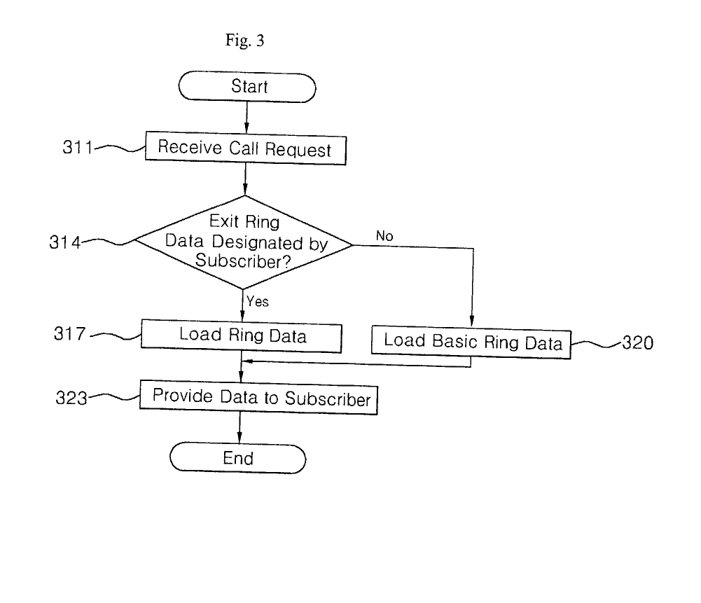

FIG. 3 is a flow chart illustrating a method for providing a ring to a subscriber terminal when an external call request is received in a PBX according to the invention. As shown, when the PBX 200 receives an external call request in step 311, the ring-providing unit 212 refers to the ring memory 213 in response to the call request to confirm whether the ring memory 213 has a ring data designated by a subscriber in step 314. The telephone number of the subscriber included in the call request may be used for reference of the ring memory 213.

As previously described, the ring memory 213 may store at least one ring data which can be designated by the subscriber. Therefore, the subscriber can manipulate key buttons of the telephone 100 to designate one of the at least one ring data as his/her ring. Alternatively, the system operator may designate one of the at least one ring data requested by the subscriber as his/her ring. In this case, the ring data designated for the subscriber may be stored in the ring memory 213 corresponding to the subscriber's telephone number.

The ring-providing unit 212 may therefore refer to the ring memory 213 to determine whether a telephone number is stored which is identical to the subscriber's telephone number. If it is confirmed that the ring data designated by the subscriber exists in the ring memory 213, the ring-providing unit 212 loads the corresponding ring data in step 317. In other words, if the subscriber's telephone number is stored in the ring memory 213, the ring-providing unit 212 loads the ring data associated with the subscriber's telephone number, in which the ring data is preferably loaded in parallel.

If the subscriber's telephone number is not stored in the ring memory 213, the ring-providing unit 212 loads the basic (and default) ring data stored in the memory 221 of the control unit 220 in step 320. The loaded basic ring data is transferred in the form of a bit string via the switch 222, and converted in parallel by the serial-parallel converting block 212c. The ring-providing unit 212 can select the basic ring data into a ring data corresponding to the subscriber's telephone number included in the call request. Further, the ring-providing unit 212 can adjust the ring data according to a prearranged level of volume, which can be adjusted at the request of the subscriber of course. The ring data selected in step 317 or the basic ring data selected step 320 is provided to the subscriber, converted in series again in step 323. Therefore, the telephone 100 rings in response to the ring data provided to the subscriber.

As set forth above, the system and method of the invention allows a telephone user to select or otherwise designate specific ring data that will cause the user's telephone to ring with a distinct ring when an external call is received. This is advantageous, in at least one respect, because when implemented in a multi-user telephone system such as a PBX system, users will be able to distinguish their respective rings from others in the system, thereby avoiding confusion. Further, the invention allows subscribers to update their own ring at any time thereby promoting convenience of the subscribers.

While the invention has been shown and described with reference to certain preferred embodiments thereof, it will be understood by those skilled in the art that various changes in form and details may be made therein without departing from the spirit and scope of the invention as defined by the appended claims. For example, while the invention has been described in the specific content of a PBX system, those skilled in the art will appreciate that the system and method may be used to manage subscriber designated ring data in any type of multi-user telephone system.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for providing a ring to a subscriber in a PBX, comprising:
confirming whether ring data designated by the subscriber exists in response to an external call request;
if the ring data designated by the subscriber exists, loading the ring data designated by the subscriber; and
providing the loaded ring data to the subscriber.

2. The method according to claim 1, further comprising:
if the ring data designated by the subscriber does not exist, loading predetermined ring data; and
providing the loaded predetermined ring data into the subscriber.

3. The method according to claim 2, wherein the predetermined ring data is loaded in parallel.

4. The method according to claim 2, wherein the loaded predetermined ring data is converted in series before provided to the subscriber.

5. The method according to claim 1, wherein the ring data designated by the subscriber is loaded in parallel.

6. The method according to claim 1, wherein the loaded ring data is converted in series before provided to the subscriber.

7. The method according to claim 1, wherein the ring data is stored based on a unique identifier of the subscriber.

8. A method for providing a ring to a subscriber in a PBX, comprising:
referring to a ring memory unit according to a unique identifier included in an external call request;
if the ring data exists in the ring memory unit, loading the ring data; and
providing the loaded ring data to the subscriber.

9. The method according to claim 8, further comprising:
if the ring data does not exist in the ring memory, loading predetermined ring data; and
providing the loaded predetermined ring data to the subscriber.

10. The method according to claim 8, wherein the ring memory unit stores at least one ring data.

11. The method according to claim 8, wherein key buttons of a terminal are manipulated to designate the ring data stored in the ring memory unit as a ring of the subscriber.

12. The method according to claim 8, wherein the ring data is stored in the ring memory unit according to a unique identifier of the subscriber.

13. A PBX system for providing a ring to a subscriber, comprising:
a ring memory unit which stores subscriber ring data;
a ring-providing unit which loads subscriber ring data from said ring memory unit, said ring-providing unit loading ring data designated by the subscriber if the subscriber previously designated the loaded ring data; and
a line interface for providing the loaded ring data to the subscriber.

14. The PBX system according to claim 13, further comprising:
a control unit which transfers predetermined ring data into said ring-providing unit through switching if the subscriber previously did not designate ring data.

15. The PBX system according to claim 13, wherein said ring-providing unit comprises:
a serial-parallel converting unit which converts the predetermined ring data from said control unit in parallel;
a ring-selecting unit which refers to the subscriber ring data stored in said ring memory unit to select a ring as a ring of the subscriber; and
a parallel-serial converting unit which converts the selected ring data in series.

16. The PBX system according to claim 15, wherein the ring-selecting unit refers to the subscriber ring data based on an identifier of the subscriber.

17. A system for providing a ring to a subscriber, comprising:
a ring memory unit for storing ring data for at least one subscriber;
a ring-selecting unit which refers to said ring memory unit in response to an external call request to select said ring data to be provided to the subscriber; and
a parallel-serial converting unit which converts the selected ring data in series.

18. The system according to claim 17, wherein said ring data is selected based on a unique identifier of the subscriber included in the call request.

19. The system according to claim 17, further comprising:
means for allowing the subscriber to designate said ring data for storage in the ring memory unit.

20. The system according to claim 17, wherein said ring-selecting unit loads the selected ring data in parallel.

21. A method for processing calls in a multiple-user telephone system, said telephone system having a memory which stores a plurality of types of ring data, each of said ring-data types causing phones within the system to have a distinct ring, said method comprising:
receiving information from a user selecting one of said plurality of types of ring data;
receiving a call for said user; and
causing a telephone of the user to ring based on said selected ring-data type.

22. The method according to claim 21, wherein said multiple-user telephone system is a PBX system.

23. The method according to claim 21, further comprising:
receiving a call for another user;
determining whether the other user selected one of said plurality of types of ring data; and
causing a telephone of the other user to ring with a default ring if the other user has not selected one of said plurality of types of ring data.

24. The method according to claim 21, further comprising:
receiving an instruction from the user to disable said selected-ring type data; and
causing the telephone of the user to ring with a default ring.

25. The method of claim 21, wherein said information is entered by the user using a keypad of the telephone.

26. A system for processing calls in a multiple-user telephone system, comprising:
a memory unit which stores one of a plurality of types of ring data selected by a user in said multiple-user telephone system, each of said ring-data types causing phones within the system to have a distinct ring; and
a control unit which causes a telephone of the user to ring when a call for the user is received, said control unit causing the telephone of the user to ring based on said selected ring-data type stored in the memory unit.

27. The system according to claim 26, wherein said multiple-user telephone system is a PBX system.

28. The system according to claim 26, wherein the control unit causes a telephone of another user to ring with a default ring if the other user has not selected one of said plurality of types of ring data.

29. The system of claim 26, wherein said ring-data type is selected by the user using a keyboard of the telephone of the user.
